(19) United States
(12) Patent Application Publication
(10) Pub. No.: US 2011/0266026 A1
(43) Pub. Date: Nov. 3, 2011

(54) FLAME RETARDANT, FLAME-RETARDANT RESIN COMPOSITION, AND INSULATED WIRE

(75) Inventor: Tsuyoshi Nonaka, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/143,527

(22) PCT Filed: Jan. 20, 2010
(86) PCT No.: PCT/JP2010/050604

§ 371 Date: Jul. 6, 2011

(30) Foreign Application Priority Data
Jan. 29, 2009 (JP) 2009-017434

(51) Int. Cl. H01B 7/295; C08L 31/04; C08L 23/06; C08K 3/22; C08L 23/12

(52) U.S. Cl. 174/110 SR; 524/436

(57) ABSTRACT

A flame retardant, a flame-retardant resin composition and an insulated wire that have an excellent low-temperature property and cold-resistance property, and high manufacturability. The flame retardant contains magnesium hydroxide that is obtained by chemical synthesis, and a surface treatment agent that contains an organic polymer having a melting point of 150° C. or more, with the surface treatment agent, a surface of the magnesium hydroxide being treated. The flame-retardant resin composition contains the flame retardant and a resin that is a base material. The insulated wire is prepared by covering and insulating a conductor with the flame-retardant resin composition.

### TECHNICAL FIELD

The present invention relates to a flame retardant, a flame-retardant resin composition and an insulated wire, and more specifically relates to a flame retardant suitably used as a flame-retardant material for a covering member of an insulated wire that is used for carrying out wiring of parts for automobile or parts for electrical/electronic appliance, and a flame-retardant resin composition and an insulated wire including the same.

### Background Art

Members and insulation materials used for parts for automobile and parts for electrical/electronic appliance require a variety of properties such as a mechanical property, a flame retardant property, a heat-resistance property and a cold-resistance property. Conventionally, an insulated wire having a configuration that a vinyl chloride resin composition that contains a halogenous flame retardant as an additive covers a conductor is in widespread use as an insulated wire used for carrying out wiring of parts for automobile and parts for electrical/electronic appliance.

However, the conventionally-used flame-retardant material could give off enormous amounts of corrosive gas in case of fire or during incineration disposal. For this reason, using instead a non-halogenous flame-retardant material that has no possibility of giving off corrosive gas is proposed. As a non-halogenous flame-retardant resin composition used for a covering layer of an electric wire, a flame-retardant resin composition is known which is prepared by adding a flame retardant to plastic or rubber for imparting a flame retardant property thereto, the flame retardant being prepared by pulverizing a natural mineral mainly consisting of magnesium hydroxide and being subsequently subjected to surface treatment using a surface treatment agent (see PTL1).

### CITATION LIST

### Patent Literature

PTL1: JP 3339154 B

### SUMMARY OF INVENTION

### Technical Problem

However, the conventionally-used non-halogenous flame-retardant resin composition that is prepared by adding the flame retardant made of natural mineral mainly consisting of magnesium hydroxide to the polyolefin resin has a problem in its low-temperature property, and accordingly do not have a sufficient cold-resistance property, which the resin composition is required to have.

In addition, the flame-retardant resin composition described above is required to have excellent kneadability and high manufacturability for manufacturing an insulated wire from the composition.

Objects of the present invention are to provide a flame retardant, a flame-retardant resin composition and an insulated wire that have an excellent low-temperature property and cold-resistance property, and high manufacturability.

### Solution to Problem

To achieve the objects and in accordance with the purpose of the present invention, a flame retardant according to a preferred embodiment of the present invention contains magnesium hydroxide that is obtained by chemical synthesis, and a surface treatment agent that contains an organic polymer having a melting point of 150° C. or more, with the surface treatment agent, a surface of the magnesium hydroxide being treated.

In the flame retardant, the surface treatment agent preferably has a melt viscosity of 10000 mPa·s or less at 180° C. The surface treatment agent is preferably a hydrocarbon resin. The surface treatment agent preferably contains one or more of materials selected from the group consisting of polyethylene, polypropylene, an ethylene-ethyl acrylate copolymer and an ethylene-vinyl acetate copolymer, and their derivatives. The surface treatment agent content is preferably 0.05 to 15 parts by mass with respect to 100 parts by mass of the magnesium hydroxide.

In another aspect of the present invention, a flame-retardant resin composition contains a resin that is a base material, and the above-described flame retardant that is an additive.

Yet, in another aspect of the present invention, an insulated wire includes a conductor, and a covering member containing the above-described flame-retardant resin composition, with which the conductor is covered and insulated.

### Advantageous Effects of Invention

Having the configuration that the surface of the magnesium hydroxide obtained by chemical synthesis is treated with the surface treatment agent containing the organic polymer, the flame retardant according to the preferred embodiment of the present invention, when contained in the flame-retardant resin composition, has excellent dispersibility into the flame-retardant resin composition more than a flame retardant containing natural magnesium hydroxide. Thus, the obtained flame-retardant resin composition has an excellent cold-resistance property. In addition, having the configuration that the surface treatment is performed with the surface treatment agent containing the organic polymer, the flame retardant according to the preferred embodiment of the present invention allows a sufficient discharge amount of the flame-retardant resin composition, containing the flame retardant that is discharged from a kneader. Thus, the flame-retardant resin composition has excellent manufacturability. Further, having the configuration that the surface treatment agent has the melting point of 150° C. or more, the flame retardant according to the preferred embodiment of the present invention, when contained as the additive in the flame-retardant resin composition to be kneaded, extruded and pelletized, can prevent the obtained pellets from forming a bubble. Thus, a product molded from the pellets of the flame-retardant resin composition has excellent surface appearance.

Containing the base-material resin and the flame retardant as the additive, the flame-retardant resin composition according to the preferred embodiment of the present invention has excellent manufacturability. Thus, a molded product made from the flame-retardant resin composition has excellent surface appearance and an excellent cold-resistance property. In addition, including the conductor and the covering member containing the above-described flame-retardant resin composition with which the conductor is covered and insulated, the insulated wire according to the preferred embodiment of the present invention has an excellent cold-resistance property, and excellent surface appearance.

### DESCRIPTION OF EMBODIMENTS

A detailed description of preferred embodiments of the present invention will now be provided. A flame retardant according to the preferred embodiment of the present invention contains magnesium hydroxide that is obtained by chemical synthesis, and a surface treatment agent with which a surface of the magnesium hydroxide is treated. It is essential only that the magnesium hydroxide obtained by chemical synthesis (hereinafter, sometimes referred to as synthesized magnesium hydroxide should be made from magnesium chloride by reaction with calcium hydroxide to synthesize the magnesium chloride and the calcium hydroxide. Specific examples of the synthesized magnesium hydroxide include synthesized magnesium hydroxide that is prepared by growing crystal molecules of magnesium hydroxide that is made from magnesium chloride contained in seawater by reaction with calcium hydroxide in an aqueous solution, and synthesized magnesium hydroxide that is obtained from a bittern.

The average particle size of the synthesized magnesium hydroxide before surface treated is 0.1 to 20 μm, preferably 0.2 to 10 μm, and more preferably 0.5 to 5 μm. This is because if the average particle size is less than 0.1 μm, secondary cohesion could easily occur to demonstrate a tendency to degrade a mechanical property of a composition to be made from the flame retardant. On the other hand, if the average particle size is more than 20 μm, a composition to be made from the flame retardant could have marred surface appearance when the composition is used for a covering member of an electric wire.

Because the synthesized magnesium hydroxide is prepared by a synthetic method, not by pulverization, initial particles of the synthesized magnesium hydroxide have a substantially spheric shape and thus have excellent dispersibility to be easily dispersed evenly into a composition to be made from the flame retardant, compared with so-called natural magnesium hydroxide that is prepared by pulverizing a natural mineral consisting of magnesium hydroxide. Consequently, when the flame retardant is contained as the additive in the composition, a molded product made from the composition has an excellent low-temperature property, and accordingly has an improved cold-resistance property.

The surface treatment agent, with which a surface of the synthesized magnesium hydroxide is treated, contains an organic polymer having a melting point of 150° C. or more. The synthesized magnesium hydroxide that is not surface treated has dispersibility more excellent than the natural magnesium hydroxide as described above, and a molded product made from the composition containing the synthesized magnesium hydroxide accordingly has an improved cold-resistance property; however, the synthesized magnesium hydroxide that is not surface treated has a problem that a discharge amount of the composition containing the synthesized magnesium hydroxide that is discharged from a kneader is small. Thus, the composition has low manufacturability. In general, surfaces of particles of magnesium hydroxide are treated with a surface treatment agent to improve liquidity of the magnesium hydroxide contained in a composition. For example, PTL1 cites surface treating a flame retardant with a surface treatment mainly consisting of a fatty acid, fatty-acid metallic salt, a silane coupling agent or a titanate coupling agent. For this purpose, the present inventor made an attempt to use a surface treatment such as a stearic acid that is used in surface treating natural magnesium hydroxide; however, manufacturability of a resin composition containing the surface-treated synthesized magnesium hydroxide was not improved. For the purpose of improving the manufacturability, the present inventor studied and found that a flame retardant that contained synthesized magnesium hydroxide that was surface treated with a surface treatment agent containing an organic polymer served a useful function, and has already filed a patent application claiming this invention with the Japan Patent Office (JP2008-283350).

However, having been reviewed later, this invention was found that while a resin composition containing the flame retardant that contains the synthesized magnesium hydroxide that is surface treated with the surface treatment agent containing the organic polymer has excellent discharging ability and manufacturability, the composition could form a bubble when pelletized by a mass producing machine. If the pellets of the composition that form a bubble are used for producing a covering member of an electric wire, the produced covering member could have marred surface appearance. It is to be noted that the conventional composition containing the flame retardant that contains the surface-treated natural magnesium hydroxide has no trouble over discharging ability or bubble formation.

In order to solve the problem of bubble formation in pelletizing a composition, the present inventor made a close study of the surface treatment agent, and found that a flame retardant that contains synthesized magnesium hydroxide that is surface treated with a surface treatment agent containing an organic polymer having a melting point of 150° C. or more can prevent bubble formation in pelletizing a composition containing the flame retardant, and thus a molded product made from the composition has excellent surface appearance. Meanwhile, it is found that a flame retardant that contains synthesized magnesium hydroxide that is surface treated with a surface treatment agent containing an organic polymer having a melting point of less than 150° C. could cause bubble formation in pelletizing a composition containing the flame retardant, and thus a molded product made from the composition could have marred surface appearance.

The melting point of the organic polymer contained in the surface treatment agent with which the surface treatment agent is surface treated is preferably 160° C. or more considering that the surface treatment agent can be restrained from moving away from the surface of synthesized magnesium hydroxide in kneading. On the other hand, the melting point is preferably 300° C. or less, and more preferably 280° C. or less considering that the surface of synthesized magnesium hydroxide can be easily coated with the surface treatment agent.

The organic polymer contained in the surface treatment agent with which the synthesized magnesium hydroxide is surface treated preferably has a melt viscosity of 10000 mPa·s or less at 180° C., and more preferably a melt viscosity of 9000 mPa·s or less at 180° C. While having the high melting point of 150° C., the organic polymer contained in the surface treatment agent has the relatively low melt viscosity, so that the surface of the synthesized magnesium hydroxide can be easily coated with the surface treatment agent uniformly. Thus, bubble formation in pelletizing the composition containing the flame retardant can be prevented without fault, which can achieve stable supply of a molded product having excellent surface appearance that is made from the composition. On the other hand, the melt viscosity of the organic polymer preferably is 10 mPa·s or more, and more preferably 50 mPa·s or more considering that the surface treatment agent can be restrained from moving away from the surface of synthesized magnesium hydroxide in kneading.

The organic polymer contained in the surface treatment agent with which the synthesized magnesium hydroxide is surface treated is a hydrocarbon resin such as a paraffinic resin and an olefinic resin. The specific examples of the hydrocarbon resin include an alpha-olefin homopolymer or copolymer such as 1-heptene, 1-octene, 1-nonene and 1-decene, mixture of the homopolymer and the copolymer, polypropylene (PP), polyethylene (PE), an ethylene-ethyl acrylate copolymer (EEA) and an ethylene-vinyl acetate copolymer (EVA), and their derivatives. It is essential only that at least one kind of the hydrocarbon resins should be contained in the surface treatment agent.

Specific examples of the polyethylene include low-density polyethylene, ultralow density polyethylene, linear low density polyethylene, high density polyethylene and metallocene polymerized polyethylene. Specific examples of the polypropylene include atactic polypropylene, syndiotactic polypropylene, metallocene polymerized polypropylene, homopolymer polypropylene and copolymer polypropylene.

The surface treatment agent may be modified by a modifying agent. Examples of the modification include acid modification that a carboxylic group (acid) is introduced into the surface treatment agent using an unsaturated carboxylic acid or its derivative as the modifying agent. The surface treatment agent, if modified by acid, easily has an improved affinity for the surface of the synthesized magnesium hydroxide. Specific examples of the modifying agent include a maleic acid and a fumaric acid as the unsaturated carboxylic acid, and a maleic acid anhydride (MAH), a maleic acid monoester and a maleic acid diester as the derivative. Among them, the maleic acid and the maleic acid anhydride are preferably used. They may be used singly or in combination.

The acid is introduced into the surface treatment agent by a graft polymerization method or a direct polymerization method. The amount of the used acid, on a percentage by mass basis of the used modifying agent, is preferably 0.1 to 20% by mass with respect to the polymers, more preferably 0.2 to 10% by mass, and still more preferably 0.2 to 5% by mass. If the amount of the used acid is smaller than the lower limit, the effect of improving the affinity of the surface treatment agent for the synthesized magnesium hydroxide tends to be lessened. On the other hand, if the amount is larger than the upper limit, the surface treatment could undergo self-polymerization, and accordingly the effect of improving the affinity of the surface treatment agent for the synthesized magnesium hydroxide tends to be lessened.

The surface treatment agent may further contain ingredients such as additives other than the organic polymer having the melting point of less than 150° C.

The surface treatment agent content is 0.05 to 15 parts by mass with respect to 100 parts by mass of the synthesized magnesium hydroxide, more preferably 0.1 to 10 parts by mass. If the content is smaller than the lower limit, the effect of improving the cold-resistance property and manufacturability of the flame-retardant resin composition containing the surface-treated synthesized magnesium hydroxide tends to be lessened. On the other hand, if the content is larger than the upper limit, while the effect of improving the cold-resistance property and manufacturability of the flame-retardant resin composition is not influenced very much, an increase in cost could be caused.

A method for surface treating the synthesized magnesium hydroxide with the surface treatment agent is not limited specifically. A variety of surface treatment methods can be used. Examples of the method for surface treating the synthesized magnesium hydroxide include a surface treatment method such that magnesium hydroxide is synthesized in advance to have a give size of particles, and then the synthesized magnesium hydroxide is blended with a surface treatment agent, and a surface treatment method such that a surface treatment agent is contained in magnesium hydroxide at the time of synthesizing the magnesium hydroxide. The surface treatment method is preferably a wet method using a solvent, or a dry method using no solvent. In using the wet method, examples of the solvent include an aliphatic hydrocarbon such as pentane, hexane and heptane, and an aromatic hydrocarbon such as benzene, toluene and xylene. In addition, examples of the method for surface treating the synthesized magnesium hydroxide include a surface treatment method such that a surface treatment agent is added to synthesized magnesium hydroxide that is yet to be surface treated and a resin that is a base material at the time of preparing a flame-retardant resin composition, and then the synthesized magnesium hydroxide is surface treated at the time of kneading the composition.

Next, a description of a flame-retardant resin composition according to the preferred embodiment of the present invention will be provided. The flame-retardant resin composition according to the preferred embodiment of the present invention contains a resin that is a base material, and the synthesized magnesium hydroxide surface treated with the surface treatment agent specified as described above that is the flame retardant and added to the base-material resin. The base-material resin contained in the flame-retardant resin composition is preferably a so-called non-halogenous plastic or rubber that contains no halogen element such as chlorine and bromine. Polyolefin and a styrene copolymer are preferably used as a material for the base-material resin. Specific examples thereof include polyethylene, polypropylene, ethylene-polypropylene rubber and a styrene-ethylene butylene-styrene block copolymer.

The flame retardant content in the flame-retardant resin composition is preferably 30 to 250 parts by mass, and more preferably 50 to 200 parts by mass with respect to 100 parts by mass of the base-material resin. If the content is less than 30 parts by mass, the flame-retardant resin composition could not have a sufficient flame retardant property. On the other hand, if the content is more than 250 parts by mass, the flame-retardant resin composition could not have a sufficient mechanical property.

The flame-retardant resin composition may further contain another additive such as an antioxidant as necessary within a range of not impairing its properties. Examples of the additive include a generally-used coloring agent, filler, antioxidant and antiaging agent that are used for a covering member of an electric wire.

The flame-retardant resin composition can be prepared by melting and kneading the ingredients with the use of a known kneader such as a Banbury mixer, a pressure kneader, a kneading extruder, a twin screw extruder and a roll. In melting and kneading, it is preferable that the base-material resin is charged and agitated in advance in the kneader, and then the flame retardant is added to the base-material resin being agitated, or that the flame retardant is charged and agitated in advance in the kneader, and then the base-material resin is added to the flame retardant being agitated. It is also preferable that the flame retardant and the base-material resin are dry blended by using a tumbler before kneading, and then transferred into the kneader to knead. After kneading, the composition is taken out of the kneader. The composition is preferably pelletized using a pelletizing machine.

The flame-retardant resin composition can be used for parts and insulation materials used for automobile or electrical/electronic appliance, and can be more preferably used for a material for an insulating layer of an insulated wire.

An insulated wire according to the preferred embodiment of the present invention is produced such that the flame-retardant resin composition is extruded by an extrusion molding machine, which is used for producing a general insulated wire, so as to cover and insulate a conductor, by which an insulating layer made from the flame-retardant resin composition is formed around the conductor. A conductor that is used for a general insulated wire is used for the conductor of the insulated wire according to the preferred embodiment of the present invention. The diameter of the conductor, and the thickness of the insulating layer of the insulated wire according to the preferred embodiment of the present invention, which are not limited specifically, may be determined depending on the intended use. The insulating layer may be a single layer, or a multilayer.

### EXAMPLE

A description of the present invention will now be specifically provided with reference to Examples and Comparative Examples.

Ingredients used in Examples and Comparative Examples are provided below along with their manufacturers, physical properties, trade names, and other information.

Base-material resin: Polypropylene resin [manuf.: JAPAN POLYPROPYLENE CORPORATION, trade name: EC7]

Synthesized magnesium hydroxide: synthesized magnesium hydroxide having an average particle size of 10 μm, which is made from magnesium chloride by reaction with calcium hydroxide [manuf.: NIHON KAISUI CO. LTD., magnesium hydroxide for industrial use]

Surface treatment agents: surface treatment agents of A to M types, which contain the respective elements shown below. Melting points (° C.), melt viscosities (at 180° C., mPa·s), and the contents (% by mass) of the surface treatment agents are shown in Tables 1 and 2.

A: Polypropylene resin [manuf.: JAPAN POLYPROPYLENE CORPORATION, trade name: BC6C]

B: Polypropylene resin [manuf.: SUNALLOMER LTD., trade name: PB170A]

C: Polyethylene resin [manuf.: JAPAN POLYETHYLENE CORPORATION, trade name: HJ360]

D: Polyethylene resin [manuf.: JAPAN POLYETHYLENE CORPORATION, trade name: HJ560]

E: Metallocene polymerized polyethylene resin [manuf.: JAPAN POLYETHYLENE CORPORATION, trade name: KS240T]

F: Metallocene polymerized polypropylene resin [manuf.: JAPAN POLYPROPYLENE CORPORATION, trade name: NEWCON]

G: EVA resin [manuf.: JAPAN POLYETHYLENE CORPORATION, trade name: LV343]

H: Polypropylene resin [manuf.: JAPAN POLYPROPYLENE CORPORATION, trade name: EC7]

I: Polypropylene resin [manuf.: JAPAN POLYPROPYLENE CORPORATION, trade name: BC6C]

J: Metallocene polymerized polypropylene resin [manuf.: JAPAN POLYPROPYLENE CORPORATION, trade name: NEWCON]

K: Stearic acid [manuf.: NOF CORPORATION, trade name: NAA173A]

L: Zinc stearate [manuf.: NOF CORPORATION, trade name: UNISTER]

M: Methacrylate silane [manuf.: SHIN-ETSU CHEMICAL CO., Ltd., trade name: KBM502]

Antioxidant ([manuf.: CIBA SPECIALTY CHEMICALS INC., trade name: Irganox 1010]

### Examples 1 to 7, Comparative Examples 1 to 6

[Preparation of Flame Retardant]

Flame retardants according to Examples and Comparative Examples were prepared as follows. While each synthesized magnesium hydroxide was being agitated in a super mixer at 200° C., each surface treatment agent shown in Tables 1 and 2 was gradually poured in the mixer over about 5 minutes. After a predetermined amount of each surface treatment agent was poured, each mixture was agitated for about another 20 minutes.

[Preparation of Flame-Retardant Resin Composition]

Flame-retardant resin compositions according to Examples and Comparative Examples were prepared by kneading the ingredients (100 parts by mass of base-material resin, 100 parts by mass of surface-treated synthesized magnesium hydroxide each surface treated with the surface treatment agents of A to M types shown in Tables 1 and 2, and 1 part by mass of antioxidant) shown in Tables 1 and 2 at 200° C. using a twin-screw kneader, and pelletizing the mixtures using a pelletizing machine. A discharge amount of the pellets of each flame-retardant resin composition being produced was measured. The pellets of each flame-retardant resin composition were observed to check for bubble formation.

[Preparation of Insulated Wire]

Insulated wires according to Examples and Comparative Examples were prepared by extrusion-covering conductors (cross sectional area: 0.5 mm²), which were soft-copper strands each prepared by bunching seven soft copper wires, with insulators made from the pellets of the prepared compositions to have a thickness of 0.2 mm using an extrusion molding machine. The obtained insulated wires were subjected to a cold-resistance test. The results are shown in Tables 1 and 2. The test procedure is described below.

[Test Procedure of Cold-Resistance Test]

The cold-resistance test was performed in accordance with JIS C3055. To be specific, the prepared insulated wires according to Examples and Comparative Examples were cut into test specimens 38 mm long. Five test specimens for each insulated wire were set in a cold-resistance test machine and hit with a striking implement while being cooled to a given temperature, and the temperature at the time when all of the five test specimens broke was determined as the cold-resistance temperature of the insulated wire.

TABLE 1

| | Example | | | | | | |
|---|---|---|---|---|---|---|---|
| | 1 | 2 | 3 | 4 | 5 | 6 | 7 |
| Ingredients of [symbol] (parts by mass) | | | | | | | |
| Olefin resin | 100 | 100 | 100 | 100 | 100 | 100 | 100 |
| Surface-treated synthesized [symbol] hydroxide | 100 | 100 | 100 | 100 | 100 | 100 | 100 |
| Antioxidant | 1 | 1 | 1 | 1 | 1 | 1 | 1 |
| Surface treatment agent to treat [symbol] | | | | | | | |
| Code | A | B | C | D | E | F | G |
| Type | PP | PP | PE | PE | [symbol] PE | [symbol] PP | [symbol] |
| [symbol] | 150 | 160 | 150 | 160 | 160 | 17 | 150 |
| [symbol] | 8000 | 2000 | 500 | 1000 | 100 | 5000 | 100 |
| Content [symbol] by mass) | 0.1 | 10 | 0.1 | 10 | 5 | 5 | 5 |
| Test result | | | | | | | |
| [symbol] | −25 | −30 | −25 | −35 | −30 | −30 | −25 |
| [symbol] | 400 | 500 | 450 | 500 | 600 | 700 | 400 |
| [symbol] | Absent | Absent | Absent | Absent | Absent | Absent | Absent |

[symbol]

indicates data missing or illegible when filed

TABLE 2

| | Comparative Example | | | | | |
|---|---|---|---|---|---|---|
| | 1 | 2 | 3 | 4 | 5 | 6 |
| Ingredients [symbol] ( [symbol] by mass) | | | | | | |
| [symbol] | 100 | 100 | 100 | 100 | 100 | 100 |
| Surface-treated [symbol] | 100 | 100 | 100 | 100 | 100 | 100 |
| Antioxidant | 1 | 1 | 1 | 1 | 1 | 1 |
| Surface treatment agent to treat [symbol] | | | | | | |
| Code | H | I | J | K | L | M |
| Type | PP | PP | [symbol] PP | Stearic acid | Zinc stearate | [symbol] |
| [symbol] | 130 | 140 | 130 | — | — | — |
| [symbol] | 500 | 100 | 15000 | — | — | — |
| Content [symbol] | 0.1 | 10 | 5 | 5 | 5 | 5 |
| Test [symbol] | | | | | | |
| [symbol] | −10 | −10 | −10 | −5 | −5 | 0 |
| [symbol] | 150 | 200 | 150 | 200 | 100 | 50 |
| [symbol] | Present | Present | Present | Present | Present | Present |

[symbol]

indicates data missing or illegible when filed

As shown in Table 1, the insulated wires according to Examples 1 to 7 had cold-resistance temperatures of −35° C. to −25° C., that is, they had a favorable cold-resistance property. In addition, the discharge amounts of the flame-retardant resin compositions according to Examples 1 to 7 were 400 kg/h or more. In addition, it is found that a bubble formed in the pellets was absent in the flame-retardant resin compositions according to Examples 1 to 7. In contrast, as shown in Table 2, the insulated wires according to Comparative Examples 1 to 6 had cold-resistance temperatures of −10° C. to 0° C., which are inferior to the insulated wires according to Examples 1 to 7. In addition, the discharge amounts of the flame-retardant resin compositions according to Comparative Examples 1 to 6 were 200 to 50 kg/h, which are inferior to the insulated wires according to Examples 1 to 7. In addition, a bubble formed in the pellets was present in all the flame-retardant resin compositions according to Comparative Examples 1 to 6.

1-7. (canceled)

8. A flame retardant containing:
magnesium hydroxide that is obtained by chemical synthesis; and
a surface treatment agent that contains an organic polymer having a melting point of 150° C. or more, with the surface treatment agent, a surface of the magnesium hydroxide being treated.

9. The flame retardant according to claim 8, wherein the surface treatment agent has a melt viscosity of 10000 mPa·s or less at 180° C.

10. The flame retardant according to claim 9, wherein the surface treatment agent comprises a hydrocarbon resin.

11. The flame retardant according to claim 10, wherein the surface treatment agent contains one or more of materials selected from the group consisting of polyethylene, polypropylene, an ethylene-ethyl acrylate copolymer and an ethylene-vinyl acetate copolymer, and their derivatives.

12. The flame retardant according to claim 10, wherein the surface treatment agent content is 0.05 to 15 parts by mass with respect to 100 parts by mass of the magnesium hydroxide.

13. The flame retardant according to claim 9, wherein the surface treatment agent contains one or more of materials selected from the group consisting of polyethylene, polypropylene, an ethylene-ethyl acrylate copolymer and an ethylene-vinyl acetate copolymer, and their derivatives.

14. The flame retardant according to claim 13, wherein the surface treatment agent content is 0.05 to 15 parts by mass with respect to 100 parts by mass of the magnesium hydroxide.

15. A flame-retardant resin composition containing:
a resin that is a base material; and
the flame retardant according to claim 14 that is an additive.

16. An insulated wire comprising;
a conductor; and
a covering member containing the flame-retardant resin composition according to claim 15, with which the conductor is covered and insulated.

17. The flame retardant according to claim 9, wherein the surface treatment agent content is 0.05 to 15 parts by mass with respect to 100 parts by mass of the magnesium hydroxide.

18. A flame-retardant resin composition containing:
a resin that is a base material; and
the flame retardant according to claim 9 that is an additive.

19. An insulated wire comprising;
a conductor; and
a covering member containing the flame-retardant resin composition according to claim 18, with which the conductor is covered and insulated.

20. The flame retardant according to claim 8, wherein the surface treatment agent comprises a hydrocarbon resin.

21. The flame retardant according to claim 20, wherein the surface treatment agent contains one or more of materials selected from the group consisting of polyethylene, polypropylene, an ethylene-ethyl acrylate copolymer and an ethylene-vinyl acetate copolymer, and their derivatives.

22. The flame retardant according to claim 20, wherein the surface treatment agent content is 0.05 to 15 parts by mass with respect to 100 parts by mass of the magnesium hydroxide.

23. The flame retardant according to claim 8, wherein the surface treatment agent contains one or more of materials selected from the group consisting of polyethylene, polypropylene, an ethylene-ethyl acrylate copolymer and an ethylene-vinyl acetate copolymer, and their derivatives.

24. The flame retardant according to claim 23, wherein the surface treatment agent content is 0.05 to 15 parts by mass with respect to 100 parts by mass of the magnesium hydroxide.

25. The flame retardant according to claim 8, wherein the surface treatment agent content is 0.05 to 15 parts by mass with respect to 100 parts by mass of the magnesium hydroxide.

26. A flame-retardant resin composition containing:
a resin that is a base material; and the flame retardant according to claim 8 that is an additive.

27. An insulated wire comprising;
a conductor; and
a covering member containing the flame-retardant resin composition according to claim 26, with which the conductor is covered and insulated.
